(19) United States
(12) Patent Application Publication
(10) Pub. No.: US 2026/0009818 A1
(43) Pub. Date: Jan. 8, 2026

(54) Physical Quantity Sensor And Physical Quantity Detection Device

(71) Applicant: SEIKO EPSON CORPORATION, Tokyo (JP)

(72) Inventors: Masayuki OTO, Okaya (JP); Kenta SATO, Shiojiri (JP)

(21) Appl. No.: 19/177,791

(22) Filed: Apr. 14, 2025

(30) Foreign Application Priority Data
Apr. 15, 2024 (JP) 2024-065323

(51) Int. Cl. G01P 15/08

(52) U.S. Cl. CPC G01P 15/08

(57) ABSTRACT

A physical quantity sensor 10 includes a base portion 21, a support portion 22 that supports the base portion 21, a plate-shaped movable portion 24 extending in one direction from the base portion 21 via a hinge portion 23, a physical quantity detection element 40 bonded to the base portion 21 and the movable portion 24 across the hinge portion 23, a package 50 that supports the support portion 22 in a fixed region 25, and a weight 30 having a pair of recessed portions 32 recessed toward a center of gravity 80 of a weight portion 31 when viewed in a direction perpendicular to a main surface 24a of the movable portion 24.

The present application is based on, and claims priority from JP Application Serial Number 2024-065323, filed Apr. 15, 2024, the disclosure of which is hereby incorporated by reference herein in its entirety.

### BACKGROUND

### 1. Technical Field

The present disclosure relates to a physical quantity sensor and a physical quantity detection device.

### 2. Related Art

For example, JP-A-2016-145755 discloses a physical quantity detection device including a base including a fixed portion and a movable portion that extends along a first direction from the fixed portion via a joint portion and is displaced according to a change in a physical quantity, a physical quantity detection element that is bridged and fixed between the fixed portion and the movable portion and detects a physical quantity according to a displacement of the movable portion, a weight portion provided in the movable portion, and a pillow portion that is provided with a gap with respect to the base and is disposed such that at least a part of the movable portion or the weight portion overlaps in a plan view viewed from a direction in which the movable portion is displaced.

JP-A-2016-145755 is an example of the related art.

However, in the physical quantity detection device described in JP-A-2016-145755, when the weight portion is fixed to the movable portion of the base, since the weight portion is sandwiched by tweezers or the like and is fixed to the movable portion, there is a concern that the weight portion is inclined and fixed to be deviated from the first direction. When the weight portion is inclined, for example, the weight portion adheres to an adhesive for fixing the base to which the weight portion is fixed to the package, and deterioration in detection sensitivity or variation in detection sensitivity occurs.

### SUMMARY

A physical quantity sensor includes a base portion, a support portion that supports the base portion, a plate-shaped movable portion extending in one direction from the base portion via a hinge portion, a physical quantity detection element bonded to the base portion and the movable portion across the hinge portion, a package that supports the support portion in a fixed region, and a weight having a pair of recessed portions recessed toward a center of gravity of a weight portion when viewed in a direction perpendicular to a main surface of the movable portion.

A physical quantity detection device includes the physical quantity sensor described above and a processing circuit that drives the physical quantity sensor and processes a detection signal.

### BRIEF DESCRIPTION OF THE DRAWINGS

FIG. 1 is a plan view illustrating a schematic structure of a physical quantity sensor according to a first embodiment.

FIG. 2 is a cross-sectional view along a line A-A in FIG. 1.

FIG. 3 is a plan view illustrating a schematic structure of a weight provided in the physical quantity sensor according to the first embodiment.

FIG. 4 is a plan view illustrating a schematic structure of the weight provided in the physical quantity sensor according to a second embodiment.

FIG. 5 is an exploded perspective view of a physical quantity detection device according to a third embodiment.

### DESCRIPTION OF EMBODIMENTS

### 1. First Embodiment

### 1.1. Physical Quantity Sensor

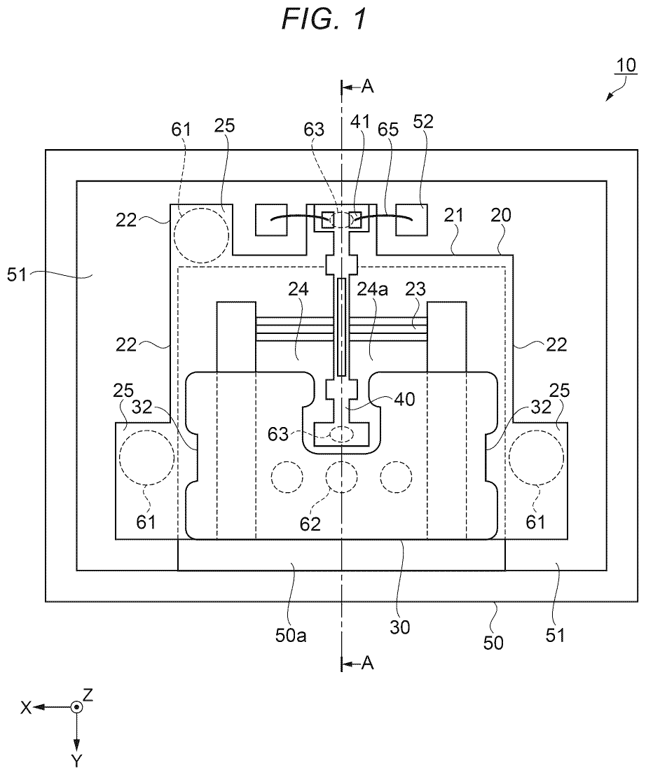

First, an acceleration sensor that detects acceleration in a vertical direction will be described as an example of a physical quantity sensor 10 according to a first embodiment with reference to FIGS. 1, 2, and 3. Note that, in FIG. 1, for the convenience of describing the internal configuration of the physical quantity sensor 10, a state in which a lid 70 is removed is illustrated.

In addition, for convenience of description, in the following plan view, cross-sectional view, and exploded perspective view, an X-axis, a Y-axis, and a Z-axis are illustrated as three axes orthogonal to each other. In addition, a direction along the X-axis is referred to as an “X direction”, a direction along the Y-axis is referred to as a “Y direction”, and a direction along the Z-axis is referred to as a “Z direction”. In addition, an arrow side of each axis is also referred to as a “positive side”, and a side opposite to an arrow is also referred to as a “negative side”. In addition, the positive side in the Z direction is also referred to as an “upper side”, and the negative side in the Z direction is also referred to as a “lower side”.

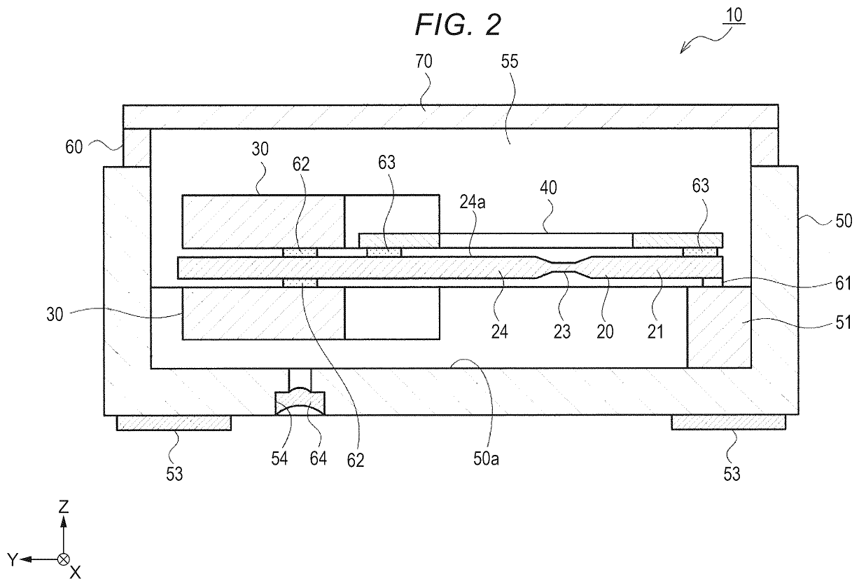

The physical quantity sensor 10 of the present embodiment can detect the acceleration of a physical quantity detection element 40 in the Z direction, which is the vertical direction, as physical quantity. As illustrated in FIGS. 1 and 2, such a physical quantity sensor 10 includes a cantilever structure 20 to which the physical quantity detection element 40 and a weight 30 are fixed, a package 50 accommodating the cantilever structure 20, and the lid 70 serving as a lid of the package 50.

The cantilever structure 20 is formed of a quartz crystal substrate and includes a base portion 21, a support portion 22, and a cantilever. The cantilever includes a hinge portion 23 and a movable portion 24.

The base portion 21 extends in the X direction, and the three support portions 22 are coupled to both ends in the X direction. Note that, the support portion 22 extending to the positive side in the Y direction and the support portion 22 extending to the negative side in the Y direction are coupled to an end portion of the base portion 21 on the positive side in the X direction, and the support portion 22 extending to the positive side in the Y direction is coupled to an end portion of the base portion 21 on the negative side in the X direction.

Each of the three support portions 22 supports the base portion 21, a base end portion thereof is coupled to the base portion 21, and a fixed region 25 fixed to a step portion 51 of the package 50 via an adhesive 61 is provided on a free end portion side.

The hinge portion 23 is disposed between the base portion 21 and the movable portion 24 and connects the base portion 21 and the movable portion 24.

The movable portion 24 has a plate shape extending from the base portion 21 to the positive side in the Y direction, which is one direction, via the hinge portion 23. In addition, the movable portion 24 is disposed between the two support portions 22 extending from both ends of the base portion 21 in the X direction to the positive side in the Y direction.

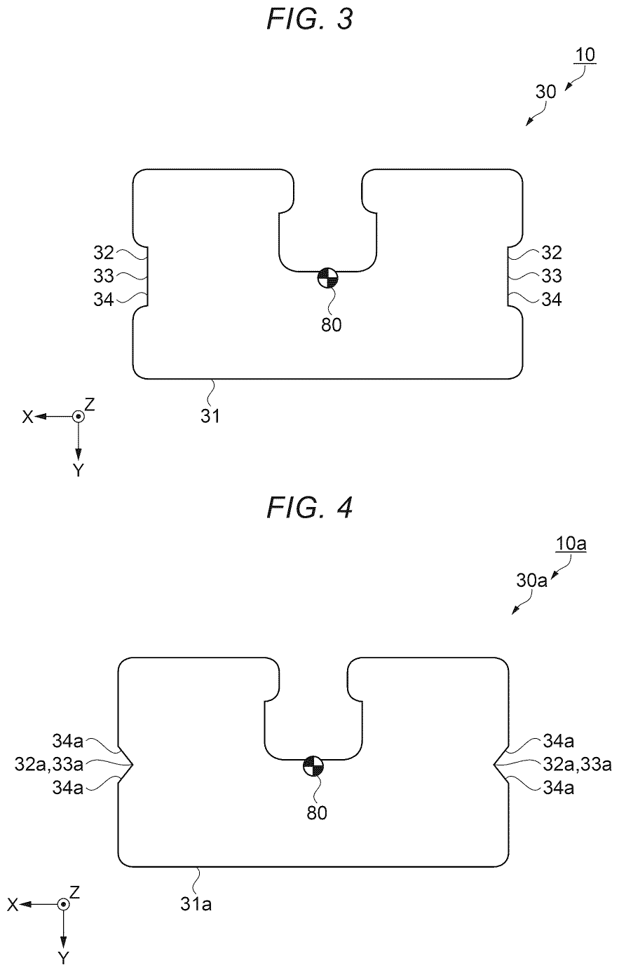

The weight 30 is made of, for example, metal such as SUS or copper, and is bonded to the upper surface and the lower surface of the free end portion side of the movable portion 24 via an adhesive 62. In addition, as illustrated in FIG. 3, the weight 30 includes a pair of recessed portions 32 recessed toward a center of gravity 80 of a weight portion 31 when viewed in the direction perpendicular to a main surface 24a of the movable portion 24. The pair of recessed portions 32 include a pair of bottom portions 33 disposed such that the center of gravity 80 is located in a region connecting the pair of recessed portions 32 when viewed in a direction perpendicular to the main surface 24a of the movable portion 24. The pair of bottom portions 33 are surfaces 34 parallel to each other. The pair of recessed portions 32 are separated from the fixed region 25 of the support portion 22 when viewed in the direction perpendicular to the main surface 24a of the movable portion 24.

Since the bottom portions 33 of the pair of recessed portions 32 are disposed at positions sandwiching the center of gravity 80 of the weight portion 31, when the weight 30 is sandwiched with tweezers or the like and fixed to the movable portion 24, the weight 30 can be lifted in a well-balanced manner and accurately disposed on the movable portion 24, so that the weight 30 can be prevented from being inclined and fixed. Therefore, it is possible to reduce the adhesion of the adhesive 61 for fixing the cantilever structure 20 to the package 50 to the weight 30 and the variation in detection sensitivity caused by the inclination of the weight 30.

The physical quantity detection element 40 is formed of, for example, a double-ended tuning fork type crystal oscillator and detects acceleration and pressure as physical quantity, for example. The physical quantity detection element 40 is disposed across the hinge portion 23 and is bonded to the base portion 21 and the movable portion 24 via an adhesive 63.

As the movable portion 24 is displaced about the hinge portion 23 as the fulcrum according to an acceleration, a stress is generated at the physical quantity detection element 40 attached to the base portion 21 and the movable portion 24. A resonance frequency serving as a vibration frequency of the physical quantity detection element 40 varies according to the stress applied to the physical quantity detection element 40. The acceleration can be detected based on the change in the resonance frequency.

The package 50 is made of, for example, ceramic, and includes the step portion 51 protruding upward, which is the positive side in the Z direction, from an inner bottom portion 50a, and the cantilever structure 20 is fixed to the package 50 by fixing the three fixed regions 25 of the cantilever structure 20 on the step portion 51 via the adhesive 61. A pair of internal terminals 52 are provided on the step portion 51 so as to sandwich the physical quantity detection element 40 located on the base portion 21. The internal terminal 52 is electrically coupled to an electrode pad 41 electrically coupled to an excitation electrode (not illustrated) for driving the physical quantity detection element 40 via a bonding wire 65. An external terminal 53 is provided on a surface of the inner bottom portion 50a opposite to the lid 70, and is electrically coupled to the internal terminal 52 via a through electrode or a wiring (not illustrated).

The lid 70 is bonded to the upper surface of the package 50 via a bonding member 60 to form an accommodation space 55 that accommodates the cantilever structure 20 to which the physical quantity detection element 40 and the weight 30 are fixed. A through-hole 54 for hermetically sealing the accommodation space 55 is provided in the inner bottom portion 50a, and the accommodation space 55 is hermetically sealed by disposing a sealing member 64 in the through-hole 54, heating and melting the sealing member 64, and then solidifying the sealing member 64.

As described above, in the physical quantity sensor 10 of the present embodiment, since the weight 30 includes the pair of recessed portions 32 recessed toward the center of gravity 80 of the weight portion 31 when viewed in the direction perpendicular to the main surface 24a of the movable portion 24, when the weight 30 is sandwiched with tweezers or the like and fixed to the movable portion 24, the weight 30 can be lifted in a well-balanced manner and accurately disposed on the movable portion 24, so that the weight 30 can be prevented from being inclined and fixed. Therefore, it is possible to reduce the adhesion of the adhesive 61 for fixing the cantilever structure 20 to the package 50 to the weight 30 and the variation in detection sensitivity caused by the inclination of the weight 30. Therefore, it is possible to obtain the physical quantity sensor 10 in which the weight 30 is accurately disposed to reduce the inclination of the weight 30, and the variation in detection sensitivity is small while suppressing an increase in manufacturing cost.

### 2. Second Embodiment

Next, a physical quantity sensor 10a according to a second embodiment will be described with reference to FIG. 4.

Note that, FIG. 4 is a plan view illustrating a structure of a weight 30a in the physical quantity sensor 10a of the second embodiment.

The physical quantity sensor 10a of the present embodiment is similar to the physical quantity sensor 10 of the first embodiment except that the structure of a recessed portion 32a of the weight 30a is different from that of the physical quantity sensor 10 of the first embodiment. Note that, the differences from the first embodiment described above will be mainly described, similar matters will be denoted by the same reference signs, and description thereof will be omitted.

As illustrated in FIG. 4, the weight 30a of the physical quantity sensor 10a is a point where a bottom portion 33a of the recessed portion 32a is defined by a surface 34a inclined with respect to a direction connecting the bottom portion 33a and the main surface 24a of the movable portion 24 when viewed in a direction perpendicular to the main surface 24a of the movable portion 24, and the center of gravity 80 is located on a line connecting the bottom portion 33a and the main surface 24a. In other words, when viewed in a direction perpendicular to the main surface 24a of the movable portion 24, the pair of recessed portions 32a have a tapered shape having, as vertices, a pair of points at which the center of gravity 80 is located on a line connecting the pair of recessed portions 32a. That is, the recessed portion 32a is recessed in a triangular shape, and the center of gravity 80 of a weight portion 31a is located on a line connecting the triangular tip of one recessed portion 32a and the triangular tip of the other recessed portion 32a.

Since the tips of the pair of recessed portions 32a are disposed at positions sandwiching the center of gravity 80 of the weight portion 31a, when the weight 30a is sandwiched with tweezers or the like and fixed to the movable portion 24, the weight 30a can be lifted in a well-balanced manner and accurately disposed on the movable portion 24, so that the weight 30a can be further prevented from being inclined and fixed.

With such a configuration, it is possible to obtain the effects similar to those of the physical quantity sensor 10 of the first embodiment. Note that, the shape of each of the pair of recessed portions 32a when viewed in the direction perpendicular to the main surface 24a does not need to be strictly triangular, and may be a shape inclined so as to guide tweezers or the like to the bottom portion 33a when gripping the weight 30a. That is, the surface 34a may be a curved surface.

### 3. Third Embodiment

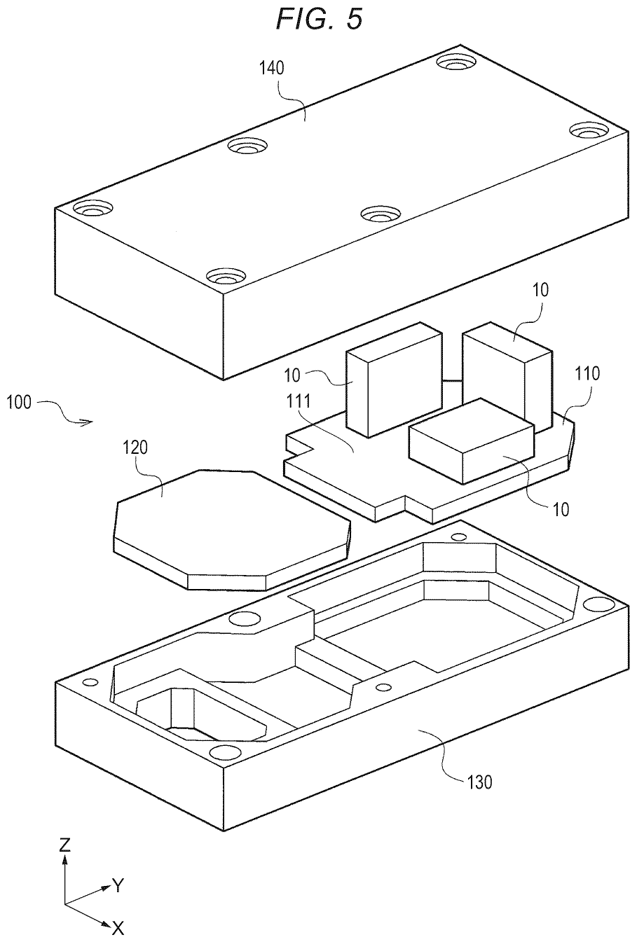

Next, a physical quantity detection device 100 according to a third embodiment will be described with reference to FIG. 5 by taking a device including the three physical quantity sensors 10 as an example.

The physical quantity detection device 100 includes the three physical quantity sensors 10, and can detect physical quantities of three orthogonal axes. Note that, the physical quantity in the physical quantity detection device 100 of the present embodiment is acceleration.

As illustrated in FIG. 5, in the physical quantity detection device 100, the three physical quantity sensors 10 are mounted on a circuit board 110 including a processing circuit 111 that drives the physical quantity sensor 10 and processes a detection signal. The three physical quantity sensors 10 are mounted on the circuit board 110 such that the respective detection axes match three axes orthogonal to each other. The circuit board 110 is electrically coupled to a connector board 120. The circuit board 110 and the connector board 120 are accommodated and held in a package formed by a package base 130 and a lid body 140.

As described above, in the physical quantity detection device 100 of the present embodiment, since the three physical quantity sensors 10 in which the weights 30 are accurately disposed are mounted along the three axes orthogonal to each other, which are the detection axes, it is possible to detect the accelerations of the three axes with high accuracy. The same applies to a case where the physical quantity detection device 100 includes the three physical quantity sensors 10a.

What is claimed is:

1. A physical quantity sensor comprising:
a base portion;
a support portion configured to support the base portion;
a plate-shaped movable portion extending in one direction from the base portion via a hinge portion;
a physical quantity detection element bonded to the base portion and the movable portion across the hinge portion;
a package configured to support the support portion in a fixed region; and
a weight having a pair of recessed portions recessed toward a center of gravity of a weight portion when viewed in a direction perpendicular to a main surface of the movable portion.

2. The physical quantity sensor according to claim 1, wherein
the pair of recessed portions include a pair of bottom portions disposed such that the center of gravity is located in a region connecting the pair of recessed portions when viewed in a direction perpendicular to the main surface of the movable portion.

3. The physical quantity sensor according to claim 2, wherein
the pair of bottom portions are surfaces parallel to each other.

4. The physical quantity sensor according to claim 1, wherein
when viewed in a direction perpendicular to the main surface of the movable portion, the pair of recessed portions have a tapered shape having, as vertices, a pair of points at which the center of gravity is located on a line connecting the pair of recessed portions.

5. The physical quantity sensor according to claim 1, wherein
the pair of recessed portions are separated from the fixed region when viewed in a direction perpendicular to the main surface of the movable portion.

6. A physical quantity detection device comprising:
the physical quantity sensor according to claim 1; and
a processing circuit configured to drive the physical quantity sensor and process a detection signal.
